(19) United States
(12) Patent Application Publication
(10) Pub. No.: US 2019/0370913 A1
(43) Pub. Date: Dec. 5, 2019

(54) Methods and Systems for Disaggregating Energy Profile for One or More Appliances Installed in a Non-Smart Meter Home

(71) Applicants: Vivek Garud, Los Altos, CA (US); Abhay Gupta, Cupertino, CA (US); Pratik Parekh, San Francisco, CA (US); Rohit Aggarwal, San Jose, CA (US); Shishir Saraiya, Mountain View, CA (US)

(72) Inventors: Vivek Garud, Los Altos, CA (US); Abhay Gupta, Cupertino, CA (US); Pratik Parekh, San Francisco, CA (US); Rohit Aggarwal, San Jose, CA (US); Shishir Saraiya, Mountain View, CA (US)

(21) Appl. No.: 16/000,209

(22) Filed: Jun. 5, 2018

(51) Int. Cl. G06Q 50/06; G06N 99/00; G06N 5/04; G06Q 30/02

(52) U.S. Cl. CPC G06Q 50/06; G06Q 30/0283; G06N 5/048; G06N 99/005

(57) ABSTRACT

The present invention is generally directed to systems and methods for disaggregating an energy profile for one or more appliances installed in a non-smart meter home. Methods may be implemented by one or more processors, and steps may include: retrieving energy consumption data, and a plurality of attributes of a non-smart meter home, retrieving energy consumption data, appliance-level energy consumption data, and a plurality of attributes of a predefined set of smart meter homes, matching the energy consumption data and the attributes of the non-smart meter home with the predefined set to identify a set of peer homes; estimating the appliance disaggregation of the non-smart meter home based on the retrieved data of the identified peer homes, and forecasting and projecting at least one of electricity bill, mid-cycle consumption, end-of-cycle consumption, disaggregation for non-smart homes, and/or combination thereof.

### BACKGROUND

In general, the present invention may directed to methods and system for accessing and displaying a plurality of data records pertaining to premises and a plurality of devices installed in the premises. Conventionally, smart meters are gas and electricity meter that digitally transmit meter readings to an energy utility or supplier for more accurate energy billing. Such smart meters may include a display screen so that a user may better understand the energy consumption of the household.

Such smart meters may provide some advantages, such providing a user with more control over energy consumption and resulting electricity bills. Additionally, a user may not have to manually check readings on the meter, as the meter readings may be automatically transmitted to the energy utility or supplier. These smart meters are a replacement for the analog meters or non-smart meters (NSM), which may use technology created decades ago and may require a qualified electricity company representative to periodically check and submit the analog meter readings.

While smart meters may provide advantages, most utilities have not rolled out smart meters to a wide audience yet. In addition, some people may not want to replace their existing analog meters or non-smart meters and prefer to stick with their current meters for various reasons—such as security, privacy of the personal data and metering data, additional cost for installation, complexities to switch energy suppliers, etc. Further, the utility or energy supplier generally bears the cost of personnel training, equipment development and production to transition to a smart-meter and new set of processes.

Disaggregation of energy profile information may generally performed on data received from a smart meter. Current disaggregation methods may rely upon high resolution data received from smart meters. In addition, disaggregation providers that utilize smart meter data may have easier access to such data (for example, through Green Button, etc.), while non-smart meter data may be more difficult to obtain and analyze.

Therefore, is a need for an integrated system and method that may be used to disaggregate energy profile for one or more appliances installed in a non-smart meter home. Furthermore, there is a need for a system and method that may utilize machine learning models and statistical tools to forecasts and projects electricity bill, mid-cycle consumption, end-of-cycle consumption, disaggregation for non-smart homes etc.

Accordingly, one advantage of the present invention may be that the energy consumption and disaggregation data of the peer's home, coupled with the disaggregated data of the non-smart meter home enables the non-smart homes to decide when to upgrade the appliance which leads to the improved efficiency of the appliances. Systems and methods in accordance with some embodiments of the present invention may provide additional advantages, such as but not limited to: (i) alerting non-smart homes in case of high usage of total energy consumption and of high usage of a certain appliance installed in the home; (ii) providing insights and recommendations to the non-smart homes based on the energy consumption and disaggregation data of the similar non-smart meter homes; and/or (iii) forecasting and projecting at least one of electricity bill, mid-cycle consumption, end-of-cycle consumption, disaggregation for non-smart homes, ways to reduce usage of devices etc.

The disadvantages and limitations of traditional and conventional approaches will become apparent to the person skilled in the art through a comparison of the described system and method with some aspects of the present disclosure, as put forward in the remainder of the present application and with reference to the drawings.

### SUMMARY OF THE INVENTION

According to some embodiments illustrated herein, there is provided a system for disaggregating energy profile for one or more appliances installed in a non-smart meter home. The system may include a processor, and a memory to store machine readable instructions that when executed by the processor to retrieve energy consumption data, and a plurality of attributes of a non-smart meter home through a first retrieving module.

The processor may be further configured to retrieve energy consumption data, appliance disaggregation data, and a plurality of attributes of a predefined set of smart meter homes through a second retrieving module. The energy consumption data may include usage duration of each appliance installed in the non-smart meter home and smart meter home. The plurality of attributes may comprises a profile of the appliance, demographic data of the non-smart meter home and the smart meter home, weather data of the non-smart meter home and the smart meter home, and geography of the non-smart meter home and the smart meter home. The retrieved appliance disaggregation may be based on at least one of the following: category of the appliance, energy consumption of the appliance, status of the appliance (always-on/On-off), the energy source of the appliance (gas based/water-based), and/or combination thereof.

The processor may be further configured to match the energy consumption data and the attributes of the non-smart meter home with the predefined set of smart meter homes to identify a set of peer homes through a matching module. Furthermore, the processor may be further configured to estimate the appliance disaggregation of the non-smart meter home based on the retrieved data of the identified peer homes through an estimation module.

As per the embodiments illustrated herein, there is provided a method for disaggregating energy profile for one or more appliances installed in a non-smart meter home. The method includes a step of retrieving, by one or more processors, energy consumption data, and a plurality of attributes of a non-smart meter home. Then, the method includes a step of retrieving, by one or more processors, energy consumption data, appliance disaggregation data, and a plurality of attributes of a predefined set of smart meter homes. The energy consumption data includes usage duration of each appliance installed in the non-smart meter home and smart meter home. The plurality of attributes includes a profile of the appliance, demographic data of the non-smart meter home, and the smart meter home, weather data of the non-smart meter home, and the smart meter home, and geography of the non-smart meter home, and the smart meter home. The retrieved appliance disaggregation data may be based on at least one of the following: category of the appliance, energy consumption of the appliance, status of the appliance (always-on/On-off), the energy source of the appliance (gas based/water-based), and/or combination thereof. Further, the method includes a step of matching, by one or more processors, the energy consumption data and the attributes of the non-smart meter home with the predefined set of smart meter homes to identify a set of peer homes. Furthermore, the method includes a step of estimating, by one or more processors, the appliance disaggregation of the non-smart meter home based on the retrieved data of the identified peer homes.

It is to be understood that both the foregoing general description and the following detailed description are exemplary and explanatory only and are not restrictive of the invention, as claimed.

### DESCRIPTION OF THE DRAWINGS

The present invention may be more fully understood by reading the following detailed description together with the accompanying drawings, in which like reference indicators are used to designate like elements. The accompanying figures depict certain illustrative embodiments and may aid in understanding the following detailed description. Before any embodiment of the invention may explained in detail, it may be understood that the invention may not limited in its application to the details of construction and the arrangements of components set forth in the following description or illustrated in the drawings. The embodiments depicted are to be understood as exemplary and in no way limiting of the overall scope of the invention. Also, is to be understood that the phraseology and terminology used herein is for the purpose of description and should not be regarded as limiting.

For example, the appended drawings illustrate the embodiments of the system and method for disaggregating energy profile for appliances installed in a non-smart meter home of the present disclosure. Any person with ordinary skills in the art will appreciate that the illustrated element boundaries in the drawings represent an example of the boundaries. In an exemplary embodiment, one element may be designed as multiple elements, or multiple elements may be designed as one element. In an exemplary embodiment, an element shown as an internal component of one element may be implemented as an external component in another and vice versa. Furthermore, the elements may not be drawn to scale. The detailed description will make reference to the following figures, in which:

FIG. 1 illustrates the flowchart of the method for disaggregating energy profile for one or more appliances installed in a non-smart meter home, in accordance with some embodiments of the present invention.

FIG. 2 represents a block diagram of the present system for disaggregating energy profile for one or more appliances installed in a non-smart meter home, in accordance with some embodiments of the present invention;

FIG. 3 illustrates an exemplary view of the steps involved in retrieving disaggregation data for non-smart meter homes, in accordance with some embodiments of the present invention;

FIG. 4 illustrates an exemplary view of identifying a set of qualified peer homes through a matched peers mechanism, in accordance with some embodiments of the present invention;

FIG. 5 illustrates an exemplary view of identifying a set of qualified peer homes through a matched region mechanism, in accordance with some embodiments of the present invention;

FIG. 6 illustrates an exemplary view of identifying a set of qualified peer homes through a multi-region learning mechanism, in accordance with some embodiments of the present invention; and

FIG. 7 illustrates an exemplary view of the forecast and projection of the electricity bill for the non-smart meter homes, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein is be made without departing from the spirit and scope of the claimed invention. Descriptions of well-known functions and constructions are omitted for clarity and conciseness. In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure may be susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

As noted above, the present invention is generally directed to methods and system for accessing and displaying a plurality of data records pertaining to premises and a plurality of devices installed in the premises. While some homes may be equipped with Smart Meters to provide such information, most homes are not. Accordingly, the present invention provides an improvement to both Smart Meter technology—and non-intrusive load monitoring and disaggregation techniques to extend this technology to what it could not do before—namely, provide disaggregation of energy in homes that generally do not provide detailed information (for example, by way of a Smart Meter that records and reports high resolution data). Moreover, the present invention allows for such disaggregation and analysis to be performed remotely, thereby obviating the need for millions of local sensors in millions of homes. In other words, the present invention both advances current technology by reducing the need for many expensive sensors, while also extending the technology into what it could not before accomplish.

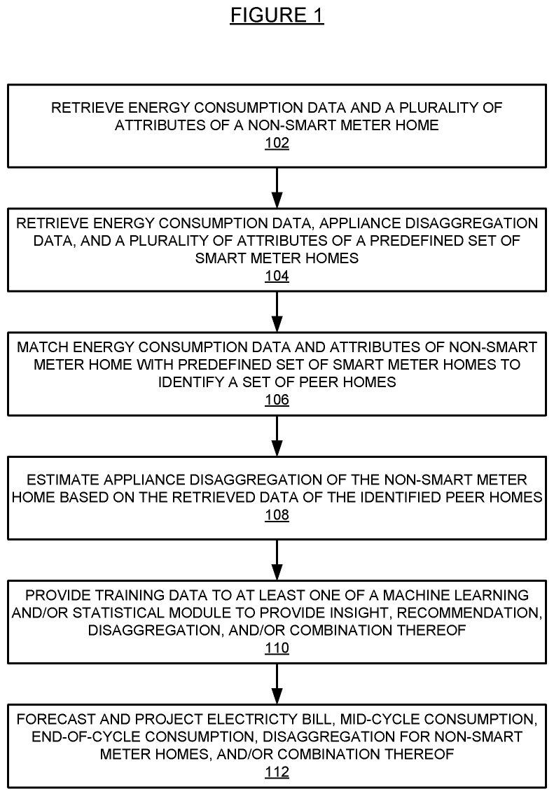

FIG. 1 illustrates the flowchart 100 of the method for disaggregating energy profile for one or more appliances installed in a non-smart meter home, in accordance with an embodiment. The method initiates with a step 102 of retrieving energy consumption data, and a plurality of attributes of a non-smart meter home. Non-Smart meter refers to an electricity meter that may be read at granularities less than or equal to once per day, typically, once per month. Then, the method includes a step 104 of retrieving energy consumption data, appliance disaggregation data, and a plurality of attributes of a predefined set of smart meter homes. In an embodiment, the predefined set of smart meter homes and the non-smart meter home have the similar characteristics in terms of energy consumption data, and attributes.

In operation, the present method identifies the appliances which may be disaggregated. Since some appliances are easier to disaggregate than other appliances, the present method ranks the order of the appliances to be disaggregated. Disaggregation of easier-to-disaggregate appliances and then removing the appliances from the original energy consumption data of a user to reduce the amount of noise remains in the signal to disaggregate other appliances. For example, for a given user, one may choose to disaggregate HVAC first by taking advantage of the seasonal energy consumption variation, then remove the disaggregated HVAC from the energy consumption signal, and finally disaggregating appliances such as Always-On. Or, one may choose to disaggregate HVAC and always-on together. Other appliances that are under consideration in this step are HVAC, lighting, washing machine, dryer, dishwasher, Always-on etc.

In an implementation, the energy consumption data includes usage duration of each appliance installed in the non-smart meter home and smart meter home. In an implementation, the plurality of attributes includes a profile of the appliance, demographic data of the non-smart meter home, and the smart meter home, weather data of the non-smart meter home, and the smart meter home, and geography of the non-smart meter home, and the smart meter home. In an implementation, the retrieved appliance disaggregation data may be based on at least one of a category of the appliance, energy consumption of the appliance, status of the appliance (always-on/On-off), the energy source of the appliance (gas based/water-based), and/or combination thereof.

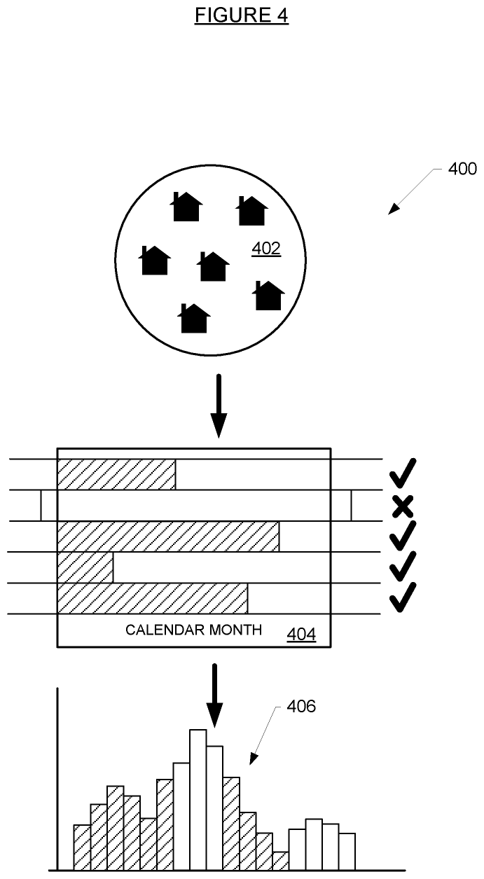

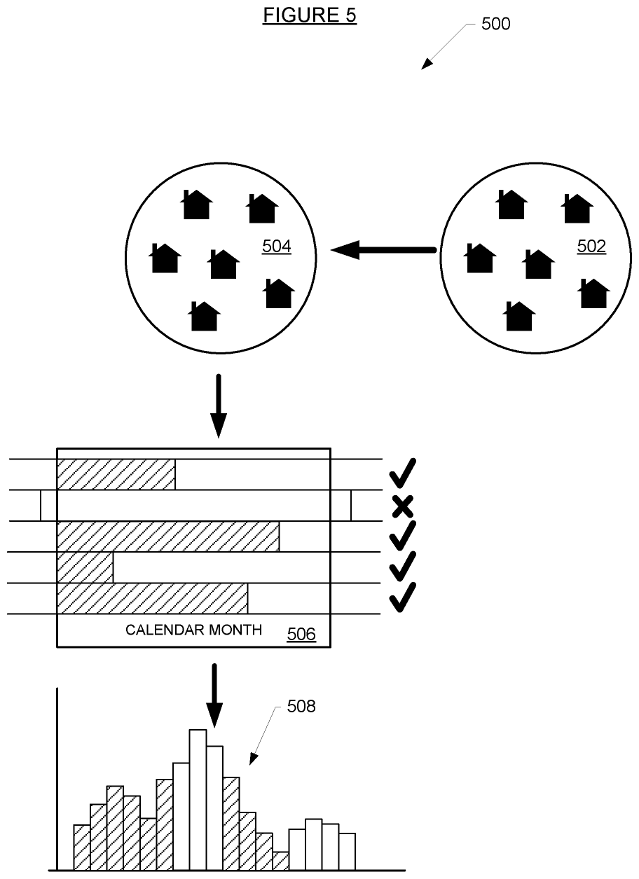

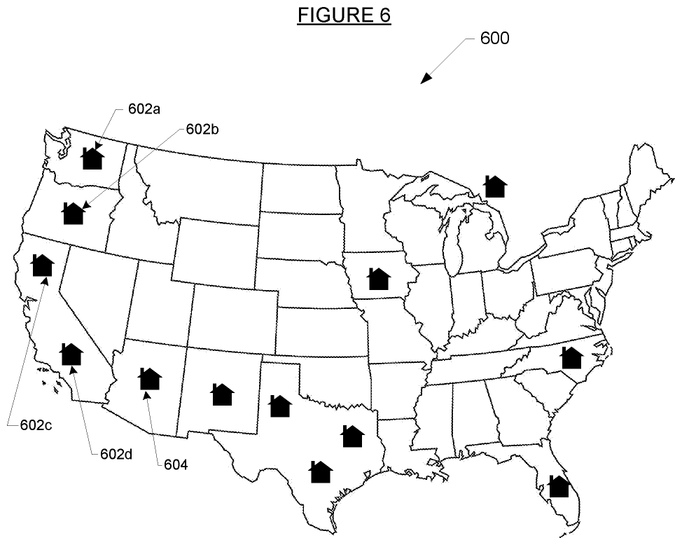

Further, the method includes a step 106 of matching the energy consumption data and the attributes of the non-smart meter home with the predefined set of smart meter homes to identify a set of peer homes. A plurality of training data sets may be utilized to derive appliance energy performance. In an embodiment, the test data may have a low resolution which may be compared with a database of medium or high-frequency training data. The database of training data includes training data for various appliance categories. Thereafter, the test data and the training data may be compared to see if there may be any match. The set of qualified peer homes may be identified through at least 3 methods such as matched peers mechanism (shown and explained in conjunction with FIG. 4), matched region mechanism (shown and explained in conjunction with FIG. 5), and multi-region learning mechanism (shown and explained in conjunction with FIG. 6). In an embodiment, the set of peer homes are selected from the predefined set of the smart meter homes.

Furthermore, the method includes a step 108 of estimating the appliance disaggregation of the non-smart meter home based on the retrieved data of the identified peer homes.

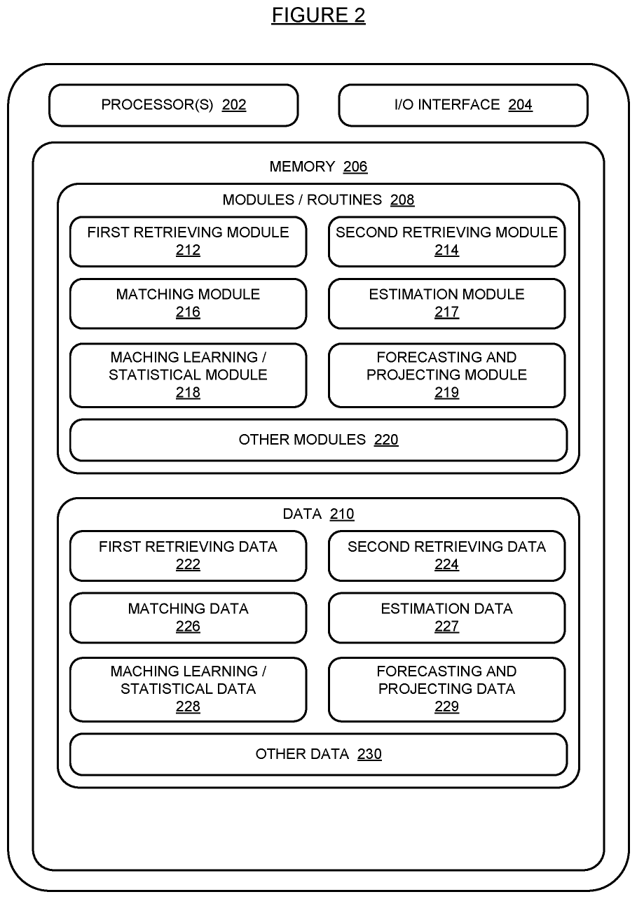

The method then includes a step 110 of providing a training data to at least one of a machine learning module, and/or a statistical module 218 (shown in FIG. 2) to provide at least one of insight, recommendation, disaggregation, and/or combination thereof. In an embodiment, the disaggregated data of the smart meter homes act as training data.

In operation, the training data may come from at least one of available ground truth via measurements or available data-sets, and/or down-sampled smart-meter home data that has disaggregation available. Once the training data may be available, a machine learning module, and/or a statistical module may be utilized to provide insight, recommendation, disaggregation etc.

The machine learning module trains a supervised learning model on smart-meter home data (“peers”). Then, the supervised learning model may be used to derive insights about non-smart meter home data. In an embodiment, the machine learning module may train a non-supervised or semi-supervised learning model on the smart-meter home data.

In order to train the supervised learning model, a training dataset with predefined inputs may be utilized. The training dataset may be available for a certain period (day, week, fortnight, months, billing cycle etc.) and has the same or higher granularity than that of the non-smart meter home. The predefined inputs include energy consumption for last “m” months; demographic data about the home; weather data for last “m” months; appliance profile; geography-based metrics; engagement metrics; and other channels of usage data like gas and water.

The energy consumption data may be in chronological order and/or in ascending order. The demographic data includes square footage of the home, lot size, type of dwelling: SFH/condo/townhouse, number of bedrooms, number of rooms, number of bathrooms, property value etc. The weather data for last “m” months include temperature, humidity, wind speed, cloud cover, UV index etc.

The appliance profile includes whether a particular appliance may be present or not, such as HVAC, WH, lighting, pool pump, dishwasher, dryer, washing machine, cooking stove, etc. Further, the type of appliance may be present such as electric/gas/hybrid/fuel tank based etc.

The geography-based metrics include latitude of home, longitude of home, Zip code of home, country of home etc. The engagement metrics include number of times the user checks his/her disaggregation in a month, feedback from the user after checking his/her disaggregation, and recommendation such as switch off some lights to save energy, changes shower and laundry schedule to save on time-of-use billing plans, high value of always-on appliances such as lighting, oven. The recommendation metrics helps to avert disasters due to negligence, for example, if the electric cooking stove may not be turned off by mistake.

The other channels of usage data include gas-based data, and water-based data such as consumption data, disaggregation data, etc. The supervised learning model may be trained on the following outputs such as appliance detection, estimation for each total energy consumption data-point of the non-smart meter home, anomaly detection in appliance disaggregation such as increased or decreased usage of the appliances, categorical outputs such as activity during the day/night/lunchtime or activity on weekends/weekdays, etc.

While training the supervised learning model the order of peers may be important. This is because a higher weightage may be given to a neighbor that is closer to the non-smart meter home, than a neighbor whom is farther. This selection and ordering may be done either on distance metrics which could be the L2 norm, earth-movers distance, Kullback-Leibler distance, etc. or peer selection should have a cutoff for distance so that only relevant peers are used to train the model.

In the statistical module, the disaggregation of non-smart meter home may be provided by applying a rule-based model. The inputs used to decide the output disaggregated non-smart meter home data are an assumption of a set of appliances and corresponding usage in a given time-period for a given home of a specific size, type, demographic features, geographical location, etc. The output may be a statistic of peers' appliance disaggregation data.

In an embodiment, the choice between using a machine learning approach or statistical approach depends on the availability of smart-meter data. If smart-meter data of peers is not available or if the available data does not match accurately with the target home, then statistical approach may be utilized.

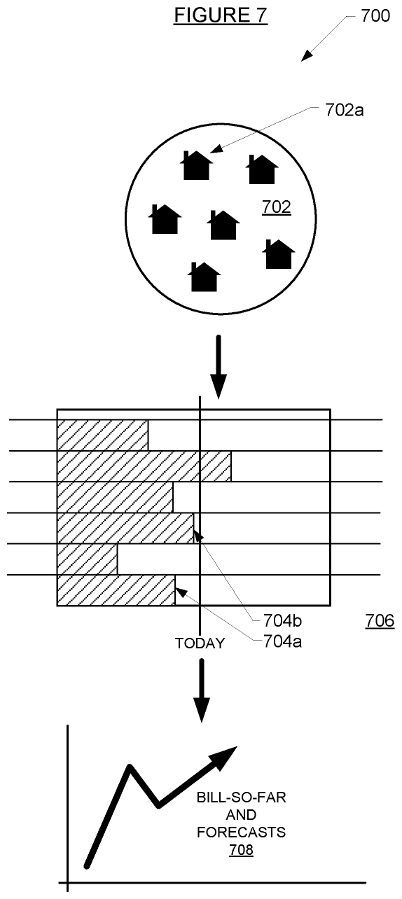

Further, the method then includes a step 112 of forecasting and projecting at least one of electricity bill, mid-cycle consumption, end-of-cycle consumption, disaggregation for non-smart homes, and/or a combination thereof (shown and explained in conjunction with FIG. 7).

FIG. 2 represents a block diagram of the present system 200 for disaggregating energy profile for one or more appliances installed in a non-smart meter home, in accordance with at least one embodiment. FIG. 2 may explained in conjunction with FIG. 1. In one embodiment, the system 200 may include at least one processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may configured to fetch and execute computer-readable instructions stored in the memory 206.

The I/O interface 204 may include a variety of software and hardware interfaces, for example, a web interface, a graphical user interface, and the like. The I/O interface 204 may allow the system 200 to interact with a user directly or through the computing units. Further, the I/O interface 204 may enable the system 200 to communicate with other computing devices, such as web servers and external data servers. The I/O interface 204may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 includes a first retrieving module 212, a second retrieving module 214, a matching module 216, an estimation module 217, a machine learning or a statistical module 218, a forecasting and projecting module 219 and other modules 220. The other modules 220 may include programs or coded instructions that supplement applications and functions of the system 200.

The data 210, amongst other things, serves as a repository for storing data processed, received, and generated by one or more of the modules 208. The data 210 may also include a first retrieving data 222, a second retrieving data 224, a matching data 226, an estimation data 227, a machine learning or a statistical data 228, a forecasting and projecting data 229 and other data 230. The other data 230 may include data generated as a result of the execution of one or more modules in the other module 220.

In one implementation, the first retrieving module 212 retrieves energy consumption data and a plurality of attributes of a non-smart meter home. In one implementation, the second retrieving module 214 retrieves energy consumption data, appliance disaggregation data, and a plurality of attributes of a predefined set of smart meter homes through a second retrieving module. In an embodiment, the predefined set of smart meter homes and the non-smart meter home have similar characteristics in terms of energy consumption data, and attributes.

The energy consumption data comprises usage duration of each appliance installed in the non-smart meter home and smart meter home. The plurality of attributes comprises a profile of the appliance, demographic data of the non-smart meter home, and the smart meter home, weather data of the non-smart meter home, and the smart meter home, and geography of the non-smart meter home, and the smart meter home. The appliance disaggregation data may be retrieved based on at least one of a category of the appliance, energy consumption of the appliance, status of the appliance (always-on/On-off), the energy source of the appliance (electricity/gas), and/or combination thereof.

In one implementation, the matching module 216 matches the energy consumption data and the attributes of the non-smart meter home with the predefined set of smart meter homes to identify a set of peer homes. In one implementation, the estimation module 218 estimates the appliance disaggregation of the non-smart meter home based on the retrieved data of the identified peer homes. In an embodiment, the set of peer homes are selected from the predefined set of the smart meter homes and/or non-smart meter homes.

In one implementation, the machine learning module, and/or a statistical module provides at least one of insight, recommendation, disaggregation, and/or a combination thereof on receiving a training data. The disaggregated data of the smart meter homes may act as training data. However, disaggregation may not be required to provide insights. The machine learning module may use the insights from the peers to get the insights of the target home.

In one implementation, the forecasting and projecting module forecasts and projects at least one of electricity bill, mid-cycle consumption, end-of-cycle consumption, disaggregation for non-smart homes, and/or combination thereof.

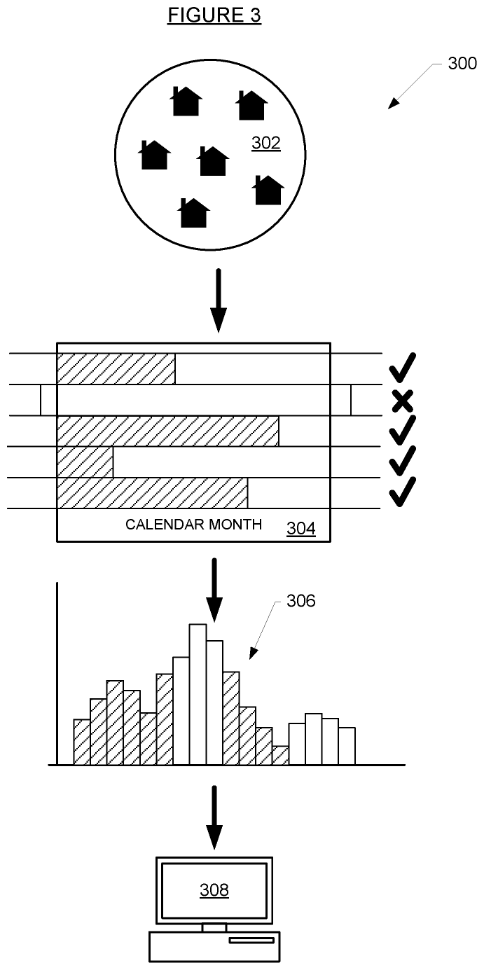

FIG. 3 illustrates an exemplary view 300 of the steps involved in retrieving disaggregation data for non-smart meter homes, in accordance with at least one embodiment. These steps include appliance identification and neighborhood detection 302, retrieving a list of qualified peers 304, non-smart meter disaggregation 306 based on qualified peers, and applications 308 based on non-smart meter disaggregation.

FIG. 4 illustrates an exemplary view 400 of identifying a set of qualified peer homes 404 through a matched peer's mechanism, in accordance with at least one embodiment. The matched peer's mechanism may be utilized when a utility company is in the process of deploying smart meters. This means the present system and method may be provided with regions that contain a mix of smart meters as well as non-smart meter homes. Then the smart meter data from similar homes or neighbors 402 may be utilized to find the closest proxy for annual energy data consumption patterns found in non-smart meter homes. The disaggregation 406 for the non-smart meter home would be generated based on the disaggregation of the closest matching peers.

The method of matched peer's mechanism includes (1) Determining the set of similar homes or peers may be based on geography, homes, and appliance profile information if available. (e.g. a home with gas based heating would only be matched against peers with gas based heating), local weather patterns, demographic information such as median income, number of bedrooms, etc., engagement metrics, such as feedback on disaggregation quality, homes with high/medium/low energy savings potential, homes with one or more similar characteristics are deemed similar. Here, the similarity may be measured by way of distance metrics. Examples of such metrics are Euclidean distance, Kullback-Leibler distance, earth-movers distance, etc.

(2) Determining the subset of (1) that has a matching annual energy profile. One of the techniques this could use would be using a number of different distance metrics and picking a minimum. One variant could be to give more weight to peers that match more closely in recent months.

(3) Determining the qualified peers: it may be possible some of the peers in (2) aren't qualified because they don't have sufficient data for a billing period we need. This could be because the billing cycle isn't complete or there may be a delay in receiving the data from the AMI network. These would be dropped to get another subset.

(4) Determining energy disaggregation: The energy disaggregation of peers in (3) could be combined in a number of ways to generate a solution for the non-smart meter home. One such way would be to use a median set of percentages across the set in (3) and apply that to the non-smart meter home.

The method of matched peer's mechanism would be optimized by performing experiments by down-sampling a number of smart meter homes down to one sample per month. This would enable finding optimal values for attributes to be used such as the number of peers to be used in the method across each step (1), (2) or (3), and the distance metrics that may be used in step (4).

FIG. 5 illustrates an exemplary view 500 of identifying a set of qualified peer homes through a matched region mechanism, in accordance with at least one embodiment. The matched region mechanism may be utilized when utility company has no smart meters in the region 502 that the present system and method are trying to provide disaggregation 508. The solution, in this case, may be to utilize peers 506 from a different but similar region 504 that has an installed base of smart meters.

The method of matched region mechanism includes determining a region that may be most similar to the non-smart meter region under consideration. The region matching could utilize a number of attributes such as annual weather patterns, overall energy consumption patterns, appliance ownership, fuel types in use, and demographic details such as median income etc.

Homes with one or more similar characteristics are deemed similar. Here, the similarity may be measured by way of distance metrics. Examples of such metrics are Euclidean distance, Kullback-Leibler distance, earth-movers distance, etc.

The subsequent steps would be identical to the steps (1), (2), (3) and (4) used in the “Matched Peer method”. This method would be optimized by performing experiments by down-sampling a number of smart meter homes down to one sample per month and trying to find matched regions. This would enable finding optimal values for a. The attributes to be used for region matching and thresholds; and b. The number of peers to be used.

FIG. 6 illustrates an exemplary view 600 of identifying a set of qualified peer homes through a multi-region learning mechanism, in accordance with at least one embodiment. The multi-region learning mechanism may be utilized when both of the above methods are rendered infeasible. This may be because there are no smart-meter peers available in the same region or in a similar region elsewhere. The infeasibility could also result from regulatory reasons or contractual clauses restricting certain uses of data.

In this case, the present system and method rely on a multi-region learning method where (1) the present system and method utilizes AMI disaggregation results obtained from all available regions that have smart meters deployed. This may be represented by “dark” shade homes (602a-d) in the FIG. 6.

(2) The present system and method down sample both the input and output data to non-smart meter resolution (1 sample per month).

(3) The present system and method set up a machine learning model that learns from the training dataset in (2). The machine learning model could use a number of automatic as well as heuristic features such as various weather attributes, demographic attributes, appliance/Fuel types, Further, the machine learning model receives input such as vector of monthly energy consumption samples, number of weather attributes such as temperature, humidity etc. demographic attributes and output a vector of disaggregated appliance categories.

(4) For any home 604 (shown in light shades in a different non-smart meter region the present system and method wants to disaggregate, the model in (3) would provide an optimal disaggregation.

In all of the above mechanisms, the matching may be in the same time-frame or different time-frames. Further, the matching may be done using the data/features from a certain time duration. This time duration may be of different lengths such, a day, week, 15-days, 2 months, quarterly etc. Furthermore, while matching a non-smart meter home, the present invention needs to match it with other homes with longer periods of training data and/or with more granular data. This may be needed because if the present system and method are matching a home with other homes with low-resolution data, it needs an abundance of data from such homes with low-resolution data to get an effective match.

Thus, the present invention improves the appliance efficiency- the peers' consumption and disaggregation data, coupled with the disaggregated data of the non-smart meter home may help in deciding when to upgrade the appliance. Further, the present invention alerts in case of high usage of total consumption and of high usage of a certain appliance. Additionally, based on the peers' recommendation, the present method provides insights and recommendations to the non-smart meter home, such as bill projection, ways to reduce always on, etc.

FIG. 7 illustrates an exemplary view 700 of the forecast and projection of the electricity bill for the non-smart meter homes, in accordance with at least one embodiment. For non-smart meter home, the present method may perform mid-cycle and end-of-cycle consumption and disaggregation forecasting based on peers' data. To do that, the present method matches non-smart meter home to peers. The matching may or may not be done within the same time-frame for all peers. So, the user may also match 2 users with different time-periods, but similar profiles (consumption, demographics, weather, appliance profile, etc). Once the matching is done, the user may perform mid-cycle and end-of-cycle consumption and disaggregation projection for a non-smart meter home for that billing cycle using the peers' data.

If the peers are from an earlier time-period, projections may be made on actual peers' data for the last billing cycle. If the peers are not from an earlier time-period, projections for non-smart meter home may be made based on peers' projections. In the case where multiple non-smart meter homes 702 are present with asynchronous billing cycles, the present invention may also match the non-smart meter home (NSM) with other NSM users. Thus the present invention considers data from the other non-smart home for disaggregation of the energy profile. This enables the user to do bill-so-far 708, and forecasts of consumption and bill for one/multiple/all appliances. The numbering 704a and 704b indicate the end of the billing cycle for qualified peers and the numbering 706 indicate the billing cycle of the light shade home 702a.

In case, matching may not for the same time-frame, historical data of non-smart meter peers allows to do forecasting and projection based on actual data from non-smart meter peers. In case, matching may be done for the same time-frame but billing cycles of different non-smart meter homes are asynchronous, actual data of non-smart meter peers allows to do forecasting and projection for the target non-smart meter home.

For bill-so-far and forecasting/projection 708, the peers may be weighted according to how close their billing cycles end to the date/time of projection for the non-smart meter home, and how close the billing cycles of peers are to the billing cycle of the non-smart meter home.

In an implementation, the present system and method are utilized as a unified software application which may be installed in the user's computing unit such as a smartphone. The unified software application may be communicatively coupled with a remotely based server. The server retrieves data from the smart-meter homes and non-smart homes and transmits the analyzed data to the computing unit of the user.

While embodiments of the present invention have been illustrated and described, it will be clear that the present invention is not limited to these embodiments only. Numerous modifications, changes, variations, substitutions, and equivalents will be apparent to the person skilled in the art, without departing from the spirit and scope of the invention, as described in the claims.

What is claimed is:

1. A method implemented, by one or more processors, for disaggregating energy profile for one or more appliances installed in a non-smart meter home, the method comprising:
retrieving, by the one or more processors, energy consumption data, and a plurality of attributes of a non-smart meter home;
retrieving, by the one or more processors, energy consumption data, appliance-level energy consumption data, and a plurality of attributes of a predefined set of smart meter homes;
matching, by the one or more processors, the energy consumption data and the attributes of the non-smart meter home with the predefined set of smart meter homes or other non-smart meter homes to identify a set of peer homes;
estimating, by the one or more processors, the appliance disaggregation of the non-smart meter home based on the retrieved data of the identified peer homes; and
forecasting and projecting, by the one or more processors, at least one of electricity bill, mid-cycle consumption, end-of-cycle consumption, disaggregation for non-smart homes, and/or combination thereof.

2. The method according to claim 1, further includes the step of providing, by the one or more processors, a training data to at least one of a machine learning module, and/or a statistical module to provide at least one of insight, recommendation, disaggregation, and/or combination thereof, wherein the disaggregated data of the smart meter homes may act as training data.

3. The method according to claim 1, wherein the predefined set of smart meter homes and the non-smart meter home have similar characteristics of energy consumption data and attributes, and wherein the set of peer homes are selected from the predefined set of the smart meter homes.

4. The method according to claim 1, wherein the energy consumption data comprises energy consumption of each appliance installed in the non-smart meter home and total energy consumption of each appliance installed in the smart meter home.

5. The method according to claim 1, wherein the plurality of attributes comprises a profile of the appliance, demographic data of the non-smart meter home and the smart meter homes, weather data of the non-smart meter home and the smart meter homes, and geography of the non-smart meter home and the smart meter homes.

6. The method according to claim 1, wherein the appliance disaggregation data is retrieved based on at least one of category of the appliance, energy consumption of the appliance, status of the appliance, energy source of the appliance, and/or a combination thereof.

7. The method according to claim 1, wherein the matching step comprises of a machine learning module to learn a pattern from the matched peer homes, a region of the peer homes, and/or a multi-region of the peer homes.

8. The method according to claim 1, wherein estimation step utilizes a machine learning module that provides at least one of an energy consumption estimation, insight, recommendation, disaggregation, and/or a combination thereof.

9. A system for disaggregating energy profile for one or more appliances installed in a non-smart meter home, the system comprising:
a processor; and
a memory to store machine readable instructions that when executed by the processor cause the processor to:
retrieve energy consumption data, and a plurality of attributes of a non-smart meter home through a first retrieving module;
retrieve energy consumption data, appliance disaggregation data, and a plurality of attributes of a predefined set of smart meter homes through a second retrieving module;
match the energy consumption data and the attributes of the non-smart meter home with the predefined set of smart meter homes or non-smart meter homes to identify a set of peer homes through a matching module; and
estimate the appliance disaggregation of the non-smart meter home based on the retrieved data of the identified peer homes through an estimation module.

10. The system according to claim 9, further includes a machine learning module, and/or a statistical module to provide at least one of insight, recommendation, disaggregation, and/or a combination thereof on receiving a training data wherein the disaggregated data of the smart meter homes may act as training data.

11. The system according to claim 9, further includes a forecasting and projecting module to forecast and project at least one of electricity bill, mid-cycle consumption, end-of-cycle consumption, disaggregation for non-smart homes, and/or combination thereof.

12. The system according to claim 9, wherein the predefined set of smart meter homes and the non-smart meter home have similar characteristics in terms of energy consumption data, and attributes, further the set of peer homes are selected from the predefined set of the smart meter homes.

13. The system according to claim 9, wherein the energy consumption data comprises usage duration of each appliance installed in the non-smart meter home, and smart meter home.

14. The system according to claim 9, wherein the plurality of attributes comprises a profile of the appliance, demographic data of the non-smart meter home, and the smart meter home, weather data of the non-smart meter home, and the smart meter home, and geography of the non-smart meter home, and the smart meter home.

15. The system according to claim 9, wherein the appliance disaggregation data is retrieved based on at least one of a category of the appliance, energy consumption of the appliance, status of the appliance (always-on/On-off), energy source of the appliance (gas based/electricity based), and/or combination thereof.

16. A method implemented, by one or more processors, for projecting electricity consumption data for one or more appliances installed in a non-smart meter home, the method comprising steps of:
matching, by one or more processors, the electricity consumption data and the attributes of the non-smart meter home for a predefined time frame with a predefined set of non-smart meter homes to identify a set of peer homes, wherein the predefined time frame may not be same for all the non-smart homes included in the predefined set of non-smart meter homes;
retrieving, by one or more processors, electricity consumption data and disaggregation data of the matched set of peer homes; and
periodically projecting, by one or more processors, the electricity consumption data and disaggregation data of the non-smart meter home for a specific billing cycle based on the retrieved data of the matched set of peer homes.

17. The method according to claim 16, wherein the periodical projection of the energy consumption data and disaggregation may perform mid-cycle and/or end-of-cycle.

18. The method according to claim 16, wherein the periodical projection is performed on actual data of the peer homes for a last electricity billing cycle, in case the peer homes are from an earlier time-frame different from the predefined time frame.

19. The method according to claim 16, wherein the periodical projection may perform based on the projection of the peer homes, in case the peer homes are not from an earlier time-frame.

20. The method according to claim 16, wherein the periodical projection is performed based on the weightage of the peer homes, wherein the weightage of the peer homes are determined according to the proximity of the billing cycles of the peer homes to the billing cycle of the non-smart meter home.
